(19) United States
(12) Patent Application Publication
(10) Pub. No.: US 2003/0098433 A1
(43) Pub. Date: May 29, 2003

(54) Pin valve

(75) Inventors: Alvaro Henao, Houston, TX (US); Anthony Zalonis, Kingwood, TX (US)

Correspondence Address: Timothy M. Donoughue, Winstead Sechrest & Minick P.C., 910 Travis Street, 2400 Bank One Center, Houston, TX, 77002, US

(73) Assignee: Piper Precision, Inc.

(21) Appl. No.: 10/303,194

(22) Filed: Nov. 25, 2002

Related U.S. Application Data
(60) Provisional application No. 60/334,298, filed on Nov. 29, 2001.

(51) Int. Cl. F16K 5/00

(52) U.S. Cl. 251/309; 251/904

(57) ABSTRACT

Disclosed is a pin valve featuring a pin that extends less than the entire length of the valve body. As a result, the valve body bore which houses the pin does not extend through the entire body. The pin is held in place through one of several retaining devices disclosed, including a compression ring. The retaining device is placed about the pin and within the valve body.

### PRIORITY CLAIM

The instant application claims the benefit of the provisional patent application entitled Pin Valve Provisional Application, filed Nov. 29, 2001, Ser. No. 60/334,298.

### BACKGROUND OF THE INVENTION

The present invention relates generally to valves for fluids and gases, and specifically to a pin valve. Pin valves are conventionally used in fluid and gas systems for the purpose of regulating pressures and flows. Pin valves inherently provide some protection against the pressures of a high-pressure system, making them a valve of choice in such systems.

Previous pin valve embodiments have had vertical borings all the way through the body casing, and have necessitated separate pin stabilizers, clamps, external rings, or external flarings to keep the pin valve in place. These valves can be problematic in that they may be tampered with, are susceptible to malfunction under extreme pressures and uses, and have more opportunity for pressure leaks and other failures (such as blowouts, etc.).

These embodiments are further problematic in that they can succumb to extreme pressure (causing the aforementioned leaks, blowouts, etc.). Additionally, the greater number of parts causes wear down over extensive use and causes them to be more susceptible to assembly and user installation error.

### SUMMARY OF THE INVENTION

The instant invention addresses many of the shortcomings of the prior art. A polygonal housing is bored axially with a bore having an ingress and egress area. A vertical bore is formed perpendicular to the axial bore to provide a housing for a pin. The vertical bore transverses less than the entire housing and has a groove therein suitable for reception of a compression ring, such as an “O” ring or snap ring. A pin having grooves suitable for the retention of a compression ring is lowered into the body by applying pressure about the circumference of the compression ring until the pin is secured in the groove within the vertical bore.

The invention provides several benefits that will immediately be evident to those skilled in the art. Among them are that the instant invention is less likely to be susceptible to tampering and less likely to malfunction under extreme pressures and uses. The instant invention also provides less opportunity for pressure leaks and other failures.

### BRIEF DESCRIPTION OF THE DRAWINGS

FIG. 1 is a side view of one embodiment of the pin valve, without the pin inserted therein;

FIG. 2 is a horizontal cross-section view taken along the lines 1-1 of FIGS. 1 and 5 and illustrating the pressure open position of the valve;

FIG. 3 is a lateral cross-section view of the pin;

FIG. 4 is a side view of the pin rotated 90 degrees from the FIG. 3 view; and

FIG. 5 is a side cross-section view of one embodiment of a pin valve, including the pin and the compression ring.

### DESCRIPTION OF THE PREFERRED EMBODIMENTS

In the following description, numerous specific details are set forth, such as materials, shapes, dimensions, relative sizes and proportions, to provide a thorough understanding of the invention to the reader. However, it will be obvious to those skilled in the art that the present invention may be practiced without such specific details and, in fact, that those embodiments described herein may be modified in many details, all falling within the teaching of this disclosure and the appended claims. In other instances, well-known applications, materials, configurations, proportions, connectors, etc. have been shown in block diagram form in order to not obscure the present invention in unnecessary detail. For the most part, details concerning manufacturing considerations, specific applications used, specific materials used, specific mechanical systems used, specific drilling or boring methods employed, and the like have been omitted inasmuch as these details are not necessary to obtain a complete understanding of the present invention. Moreover, these details are deemed well within the skills of persons of ordinary skill in the art.

Like characters of reference designate like parts in those figures of the drawings in which they occur.

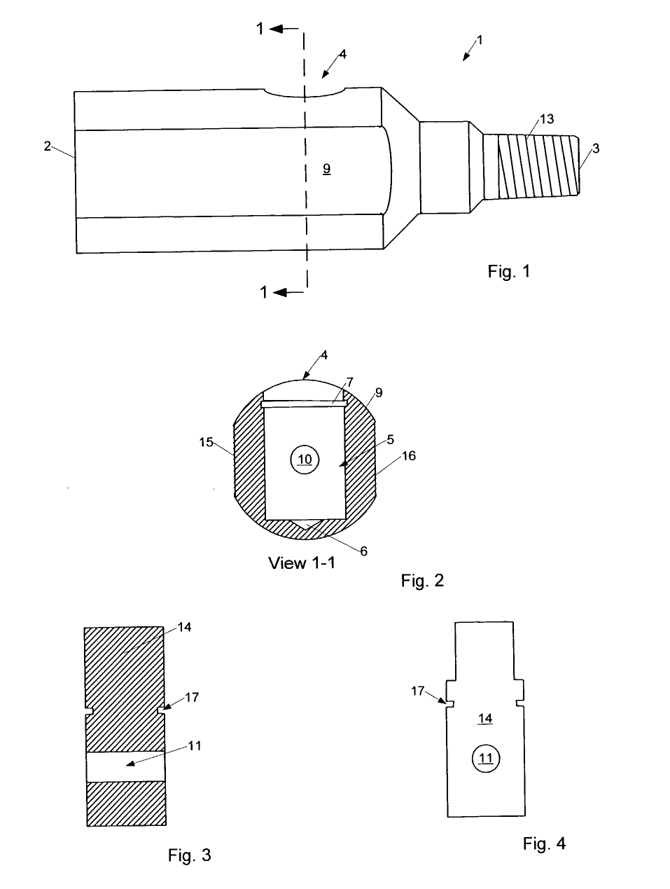

Referring first to FIG. 1, depicted is a pin valve 1 of the instant invention, omitting the pin itself. The pin valve 1 comprises an elongated tubular body 9 in general configuration. The body 9 may be made of steel, other hard material or any other material suitable for valve making, as is well-appreciated in the art.

The body 9 features an entrance end 2 and an exit end 3. Though the body 9 is referenced as having an entrance end 2 and an exit end 3, the reader will appreciate that those designations are merely for the convenience of description. In point of fact, depending upon the use to which the pin valve 1 is put, the fluid or gas regulated by the pin valve 1 may enter either the entrance end 2 or the exit end 3, the function of the pin valve 1 being essentially the same in either direction. In some applications, the flow regulated by the pin valve 1 may alternately flow in either direction.

The entrance end 2 and the exit end 3 feature means by which the pin valve 1 may be connected to other equipment, such as piping, tubing, vessels or other equipment which supplies or accepts the flow of fluid or gas. In one embodiment, the connection means is a threading 13, as demonstrated on FIG. 1 at the exit end 3. The entrance end 2 and the exit end 3 may be formed into other connectors, all falling within the connection means described, such as quick-connectors (male and female), welds, and threads (male and female), such as the one indicated with reference number 13.

The body 9 also has bored therein a pin housing area 4. Though the term “bored” is used here and throughout this specification, it is to be appreciated that any means of making a hole in the material of the body 9 is referenced thereby, including the molding of the body 9 directly into a shape containing the hole described. Accordingly, “bored” includes any hole accomplished either by drilling, casting, die-casting, individual part assembly, or any other method as is well-known and appreciated in the art. While the pin housing area 4 is shown on the top of the body 9, those skilled in the art will appreciate that the top of the body 9 is a relative location, such that the pin housing area 4 may be located at any point around the circumference of the body 9 without affecting the function of the pin valve 1.

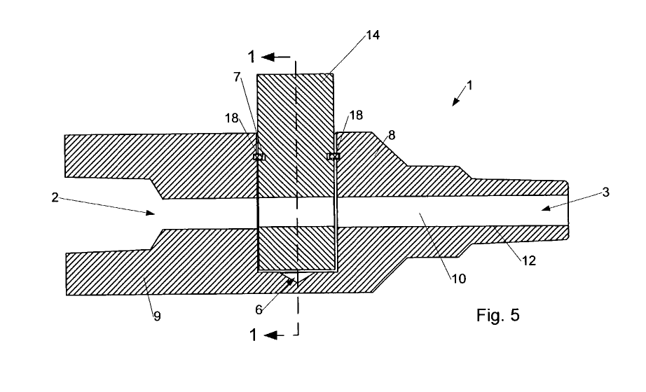

Referring now to FIG. 2, which is a cross-section view of FIGS. 1 and 5 taken substantially along the line 1-1. The pin housing area 4 is shown in cross section. The body 9 has a hole bored through its length to create a horizontal passage 10. The horizontal passage 10 extends from the entrance end 2 (FIG. 1) to the exit end 3 (FIG. 1). A small divot 6, conical in nature, may be bored at the bottom of the vertical incursion of the pin housing area 4 in one embodiment of the invention. The small divot 6 may be omitted without impeding the functionality of the valve, but its existence as a result of drilling is permissible.

The pin housing area 4 features a slot 7 circumventing the pin housing area 4 and recessed into the body 9. An external slot 7 suitable for accepting a compression ring, such as an “O” ring (not shown) or snap ring (not shown) is bored, machined or molded as indicated. The term “compression ring” as used in this application includes not only “O” rings and snap rings, but also all other rings, including partial rings, that perform a retaining function in a like manner to snap rings and “O” rings. It is important to note that the slot 7 need not be at any particular location along the pin housing area 4, except that it should not ideally be located within the intersectional area between the pin housing area 4 and the horizontal boring 10.

Referring now to FIG. 3, which is a cross sectioned view of a pin 14. Though shown in cross-section, the pin 14 is essentially cylindrical, having a flow hole 11 bored therethrough. The pin 14 has a groove 17 formed along it, of suitable size and shape for the placement of a compression ring (not shown), and is of a width that is comparable to that of the slot 7 (FIG. 2) of the pin housing area 4 (FIG. 2).

Referring now to FIG. 4, the pin 14 is shown in lateral view, rotated 90 degrees from the view in FIG. 3. Accordingly, the flow hole 11 in the pin 14 is shown providing access through the pin 14. The flow hole 11, as with all borings in this specification, may be drilled, cast, assembled, or by any other method known or appreciated in the art. The groove 17 for hosting the compression ring (not shown) circumnavigates the pin 14. In an alternative embodiment (not shown), the groove 17 may be formed to accept a partial compression ring, in which case the groove 17 would not need to completely circumnavigate the pin 14.

The full assembly of the pin valve 1 is shown with reference to FIG. 5. The body 9 is hollowed at the entrance end 2 through to the exit end 3, forming the horizontal passage 10. The pin 14 sits within the valve pin housing area 4, and may have on top thereof any number of means to facilitate the turning of the pin 14, such as a handle, a clasp, a screwdriver slot, a hex slot, or any other number of turning facilitating means well-appreciated within the art. A compression ring 18, such as an “O” ring or a snap ring, is positioned so as to fit into the groove 17 on the pin 14. The compression ring 18 may be formed out of any number of materials, but is formed of metal in one embodiment so as to provide structural strength to the pin valve 1 and not permit the pin 14 to be removed from the pin housing area 4.

The pin 14 is inserted into the body 9 by compressing the compression ring 18 by mechanical means as well-appreciated in the art, whereby the pin 14 can be inserted into the body 9 with the compression ring 18 fitting ultimately into the groove 17 in the pin 14 and the slot 7 in the body 9. Additional sealing “O” rings (not shown) may be added anywhere along the pin 14, with or without accompanying groves and slots (not shown) for the purpose of sealing the pin valve 1 against leakage. Sealing “O” rings may be formed out of rubber, tyvex, vitor or any other number of substances well-appreciated in the art for sealing.

As to the specific manner of operation and use of the present invention, the same is made apparent from the foregoing discussion. However, for the sake of clarity, several key applications of the invention are highlighted. The foregoing invention includes applications for the wells and drilling, refining, chemical processes, high-pressure chambers and all locations where valves are currently used or could be used, and the like.

With respect to the above description, it is to be realized that although embodiment of specific material, representations, proportions, applications, and configurations are disclosed, those enabling embodiments are illustrative and the optimum relationship for the parts of the invention may include variations in composition, form, function, coupling and connection, and manner of operation or manufacture, which are deemed readily apparent to one skilled in the art in view of this disclosure. All relevant relationships to those illustrated in the drawings and the specification are intended to be encompassed by the present invention.

Therefore, the foregoing is considered as merely illustrative of the principles of the invention. Numerous modifications will readily occur to those skilled in the art. It is not desired to limit the invention or the claims to the exact construction and operation shown or described, and all suitable modifications and equivalents may be resorted to, falling within the scope of the invention.

What is claimed is:

1. A pin valve comprising:
a body having a bore and a pin housing area; and
a pin seated within the pin housing area,
wherein the pin housing area transects less than the entire body.

2. The pin valve of claim 1 wherein the pin housing area is essentially perpendicular to the bore.

3. The pin valve of claim 1 further comprising a compression ring,
wherein the compression ring circumnavigates the pin and rotatably affixes the pin within the pin housing area.

4. The pin valve of claim 3 wherein the pin housing contains a groove suitable to accept the compression ring.

5. The pin valve of claim 3 further comprising a sealing ring,
wherein the sealing ring circumnavigates the pin.

6. The pin valve of claim 3 wherein the compression ring is an “O” ring.

7. The pin valve of claim 3 wherein the compression ring is a snap ring.

8. The pin valve of claim 3 wherein the compression ring is a partial “O” ring.

9. The pin valve of claim 2 further comprising a snap ring,
wherein the snap ring circumnavigates the pin and rotatably affixes the pin within the pin housing area.

10. A valve comprising:
a body having a bore axially therethrough and a pin housing bore formed only partially through the body and substantially perpendicular to axial bore; and
a pin within the pin housing bore.

11. The valve of claim 10 wherein the pin is retained within the pin housing bore by a retaining means which permits rotation of the pin within the pin housing bore.

12. The valve of claim 10 further comprising a first connector, said first connector fixably attached to the body at the axial bore.

13. The valve of claim 10 further comprising:
a snap ring,
wherein the snap ring rests in a groove about the pin, and
wherein the snap ring also rests in a groove about the pin housing bore.

14. The valve of claim 10 further comprising:
an “O” ring,
wherein the “O” ring rests in a groove about the pin, and
wherein the “O” rink also rests in a groove about the pin housing bore.

15. The valve of claim 12 wherein the snap ring is an “O” ring.

16. The valve of claim 12 further comprising:
a sealing ring,
wherein the sealing ring rests in a second groove about the pin, and
wherein the sealing ring also rests in a second groove about the pin housing bore.

17. A pin valve comprising:
a body having a first end, a second end and two parallel sides and having a bore axially therethrough between the first end and the second end; and
a pin having a bore laterally therethrough,
wherein the body has a second bore only partially through the body and substantially perpendicular to axial bore, and
wherein the pin is positioned within the second bore.

18. The pin valve of claim 17 further comprising a means for retaining the pin within the second bore.

19. The pin valve of claim 17 wherein the body further comprises:
a first connecting means fixably attached to the first end of the body, and
a second connecting means fixably attached to the second end of the body.

20. The pin valve of claim 19 wherein the first connecting means is formed to the body.

21. The pin valve of claim 18 wherein the means for retaining the pin is a compression ring.

22. The pin valve of claim 18 wherein the body further comprises:
a first connecting means fixably attached to the first end of the body, and
a second connecting means fixably attached to the second end of the body.

23. The pin valve of claim 22 wherein the first connecting means is formed to the body.
